(19) United States
(12) Patent Application Publication
(10) Pub. No.: US 2008/0314933 A1
(43) Pub. Date: Dec. 25, 2008

(54) RAPID FLOW BOTTLE

(76) Inventor: CHRISTOPHER LEONOFF, MONTEREY, CA (US)

Correspondence Address: DYKAS, SHAVER & NIPPER, LLP, P.O. BOX 877, BOISE, ID, 83701-0877, US

(21) Appl. No.: 12/054,307

(22) Filed: Mar. 24, 2008

Related U.S. Application Data
(60) Provisional application No. 60/896,763, filed on Mar. 23, 2007.

(51) Int. Cl. B65D 37/00; B67D 3/00

(52) U.S. Cl. 222/215; 222/478; 222/481

(57) ABSTRACT

A one-way air valve that is mounted at one end of a beverage or viscous fluid container, with one end possessing a conventional bottle opening, the one-way air valve being an elastomeric type valve which may be mounted on the container bottom, sidewall or lid. The valve mounted into the container to avoid breakage and prevent leakage, while providing smooth, rapid, flow of contents, reduced aeration and reduced container deformation.

### CROSS-REFERENCE TO RELATED APPLICATIONS

This application claims the priority date of the provisional application entitled BOTTLE WITH AIR VALVE filed by Christopher Leonoff, on Mar. 23, 2007 with application Ser. No. 60/896,763.

### FIELD OF THE INVENTION

This invention relates to a container for dispensing contents with improved flow, and more particularly to a container having a conventional bottle opening at one end, a vessel holding the contents, fluid or viscous content, and a one-way air valve to admit ambient air on demand for pressure equalization while preventing leakage of the contents which allows rapid and smooth outpouring of contents.

### BACKGROUND OF THE INVENTION

Conventional beverages and dispensing containers have a major disadvantage in that as fluid is removed a slight vacuum is formed within the container. An inconvenience is presented because the user must take action to equalize internal container pressure. This may be accomplished by the user adjusting their lips to allow ambient pressure into the container, removal of the container from the mouth, or in the case of a squeezable container, waiting for it to regain its form. Additionally, the following disadvantages exist: restricted flow, turbulent flow, aeration, slow gravity pouring of viscous fluids, squeeze containers that only flow by squeezing, unpleasant departure of lips from a container with low internal pressure, and backwash.

Conventional squeeze bottles used within athletic scenarios suffer a major disadvantage in that flow is restrictive. Within scenarios where proper hydration in minimum time is considered an advantage, the squeeze bottle's flow is limited. Contents drawn from squeeze bottles are aerated, the user must also wait for the container to regain its form after squeezing and before drinking again, and most squeeze bottles will not gravity pour.

Baby bottles configured with one-way air valves suffer a major disadvantage in that the nipple inhibits outward flow and smooth outpouring. Thus, baby bottle nipples are not employed in scenarios where pouring and flow may be an advantage.

Each of these examples of liquid containers does not solve the problem of allowing the user of a container to rapidly dispense liquid into the user's mouth without the need to admit air through the dispensing opening.

Therefore, there exists a need for a container for beverages or viscous fluids with an air intake valve which provides constant air pressure equalization and improved flow for drinking or dispensing containers providing: smoother flow, increased flow, reduced aeration, and reduced container deformation for flexible containers.

### SUMMARY OF THE INVENTION

An air intake valve on a container to provide constant air pressure equalization between the inside and the outside of the container to reduce restricted flow, turbulent flow, aeration and container deformation, and increase flow capacity, smoothness of flow, and user convenience.

The container itself is comprised of a rigid or flexible vessel that is substantially hollow and cylindrical and that has at one end a conventional bottle or beverage opening or lid with an opening and which also comprises, a one-way air valve located near the container's opening or at the opposite end of the container. The size of the opening utilized and the size of the air valve used are key to flow characteristics, and the degree of aeration of contents and container deformation control. The valve is sized to provide continuous outflow and air pressure equalization while the consumer is drinking or dispensing the contents.

The one-way air valve can be constructed from a molded piece of flexible impervious (water and food proof) material, preferably silicone rubber and may be of the duckbill, umbrella or ball type, all of which are integrally formed or molded with a groove that fits sealably into a hole in the vessel's bottom, side or lid. Alternatively, the valve may be retained inside a mounting hole with a retaining component. A filter may be employed on the inlet side of the valve to filter air going into the container.

The bottle's opening can be integrated with the vessel or it may be attached as a threaded fixture. It may be conventionally designed and its type is not critical.

In operation, in accordance with the present invention, the valve is mounted so that the convex side of the one-way air valve is on the inside of the bottle or dispensing container and the concave side is on the outside of the bottle or dispensing container. With the air valve installed on the top of the container, the valve may be integrated with the cap or lid, in which case the corresponding vessel may be entirely conventional. The air valve functions as a one-way valve which permits air that is under ambient pressure to be received inside the bottle based on the removal of liquid by the consumer through the container's opening as the contents are being emptied by the consumer. The slit opening in the one-way air valve is sized to permit adequate inflow of air. If an umbrella valve is employed, air vents are sized to permit ample airflow.

It is, therefore, an object of the present invention to provide a beverage or dispensing container with a one-way valve for improved dispensing and outflow of the contents through the container's opening, which provides a less restricted and/or rapid outflow of contents.

It is, therefore, an object of the present invention to provide a beverage or dispensing container with a one-way air valve for improved dispensing and outflow of the contents, which provides a smooth, laminar outflow of contents.

It is, therefore, an object of the present invention to provide a beverage or dispensing container with a one-way valve for improved dispensing and outflow of the contents, which reduces aeration of the contents through the container opening while the contents are poured or consumed, or diverts aeration away from the container's opening.

It is, therefore, an object of the present invention to provide a beverage or dispensing container with a one-way air valve for improved dispensing and outflow of contents, which does not require user to take action to equalize container pressure, thus providing a more convenient container.

It is, therefore, an object of the present invention to provide a rigid dispensing container with a one-way air valve for improved dispensing and outflow of contents, which provides improved gravity pouring of viscous fluids.

It is, therefore, an object of the present invention to provide a beverage or dispensing container with a one-way air valve for improved dispensing and outflow of contents, which in the embodiment of a flexible or squeezable container with a one-way air valve, permits low restriction gravity outpouring of contents, in which squeezing of the container is not required.

It is, therefore, an object of the present invention to provide a beverage or dispensing container with a one-way air valve for improved dispensing and outflow of the contents for sports hydration as a time benefit, and is a further advantage when the user is short of breath or fatigued.

It is, therefore, an object of the present invention to provide a beverage or dispensing container with a one-way air valve for improved dispensing and outflow of the contents, which provides a more pleasant departure of the user's lips from container's opening which may be in a state of low pressure.

It is, therefore, an object of the present invention to provide a beverage or dispensing container with a one-way air valve for improved dispensing and outflow of the contents, which reduces backwash.

It is, therefore, an object of the present invention to provide a flexible beverage container with a one-way valve for improved dispensing and outflow of the contents, which will prevent container deformation and noise associated with internal container pressure fluctuation.

It is, therefore, an object of the present invention to provide a beverage container with improved flow characteristics in squeezing scenarios, suction scenarios, and gravity pouring scenarios.

Another object of the invention is to provide a simple valve mechanism, which will permit ambient air to enter the bottom of the container and prevent the contents of the container from leaking through the air intake valve.

Still another object of the invention is to insure that the one-way valve will not be struck if the container is dropped.

Yet another object of the invention is to provide an air pressure equalization valve which may be easily cleaned and may be removable.

Yet another object of the invention is to provide a lid which comprises an opening where contents can be poured out or removed, and a one-way air valve which compensates for pressure variations inside the container once the lid is sealed with the container.

Yet another object of the invention is to provide a lid, which is twisted or opened to allow ambient air to access an air valve mounted underneath the twistable component of the lid, and when twisted shut or closed, seals the air valve from ambient air pressure. Such an embodiment may be advantageous within the beverage and food markets because the technology is incorporated into the lid and not the vessel.

### BRIEF DESCRIPTION OF THE DRAWINGS

FIG. 1 is a perspective view of a water bottle of the invention.

FIG. 2 is a side cross-sectional view of a water bottle and duckbill valve of the invention.

FIG. 3 is a side cross-sectional view of a water bottle and an umbrella check valve of the invention.

FIG. 4 is a side cross-sectional view of a water bottle and check valve of the invention.

FIG. 5 is a view of a filter element associated with the check valve.

FIG. 6 is a view of a cross-sectional view of a rigid container and check valve of the invention.

### DESCRIPTION OF THE PREFERRED EMBODIMENTS

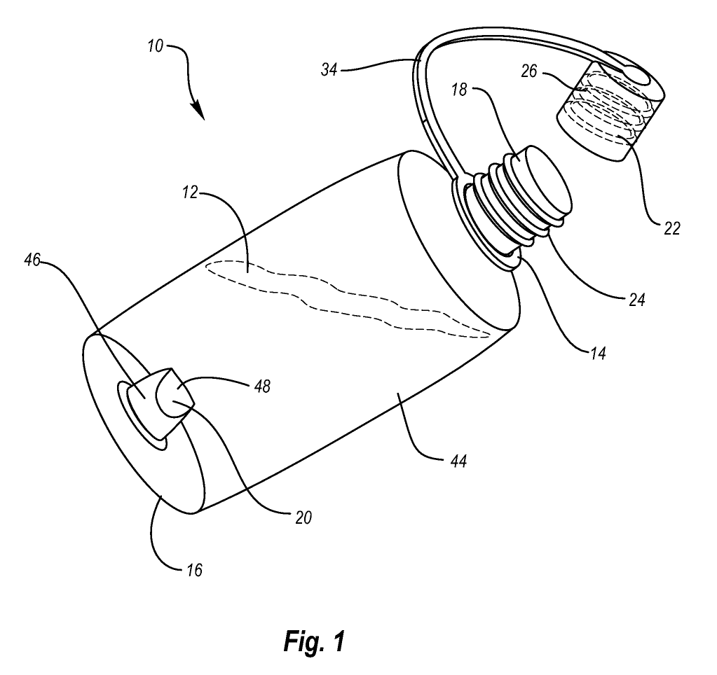

Shown in the figures are several preferred embodiments of the invention. FIG. 1 shows a container 10 with a container body 12, a container top 14, a container bottom 16, and a sealable mouthpiece 18. Also shown is a check valve 20 which is located in the container bottom 16. The check valve 20 allows air to enter from the environment into the interior of the container 10, but does not allow liquid to exit through the check valve from inside the container. Shown in FIG. 1 is a configuration of container which includes threads 24 on the neck of the container, and threads 26 in the cap of the container. In this configuration, the container 10 includes a tether 34 for attaching the cap 22 to the container body 12.

The container body 12 can be made from a number of different materials including polyethylene, polyethylene terephthalate (pet), polycarbonate, polypropylene, high and low density polyethylene and polypropylene and other types of plastics which have suitable characteristics.

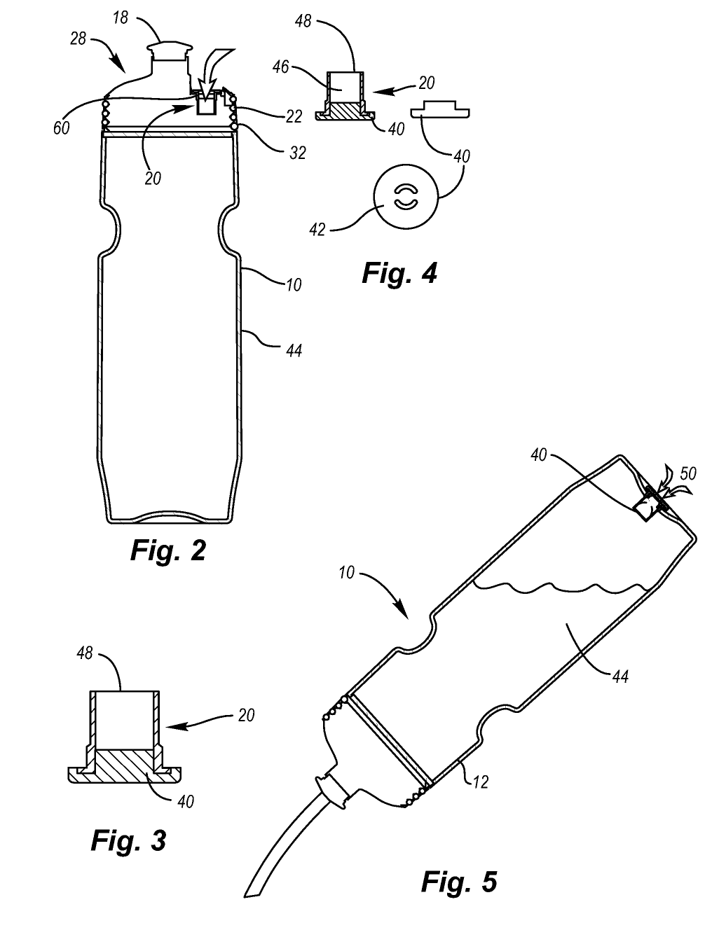

FIG. 2 shows another preferred embodiment of the invention in which the check valve 20 is of a type called a duckbill. The duckbill check valve 46 is sealably mounted within container body with valve retainer 40, which supports and holds in place duckbill check valve 46 within mounting hole 60. Compression upon the walls of duckbill 46 from both the mounting hole 60 and the valve retainer 40 provide adequate sealing and holding. Valve retainer 40 may also serve as a vented cover. Under pressure or neutral pressure the sides of the duckbill are urged together causing slit 48 to remain sealed. In an upright position, liquid in the container 10 is at neutral or positive pressure whereby slit 48 between sidewalls remains sealed. When inverted and liquid 44 exits through sealable mouthpiece 18 reduced internal container pressure causes slit 48 to open and admit air into container body 12. Minivalve brand duckbill check valves have proven to be satisfactory for use with the container of the invention.

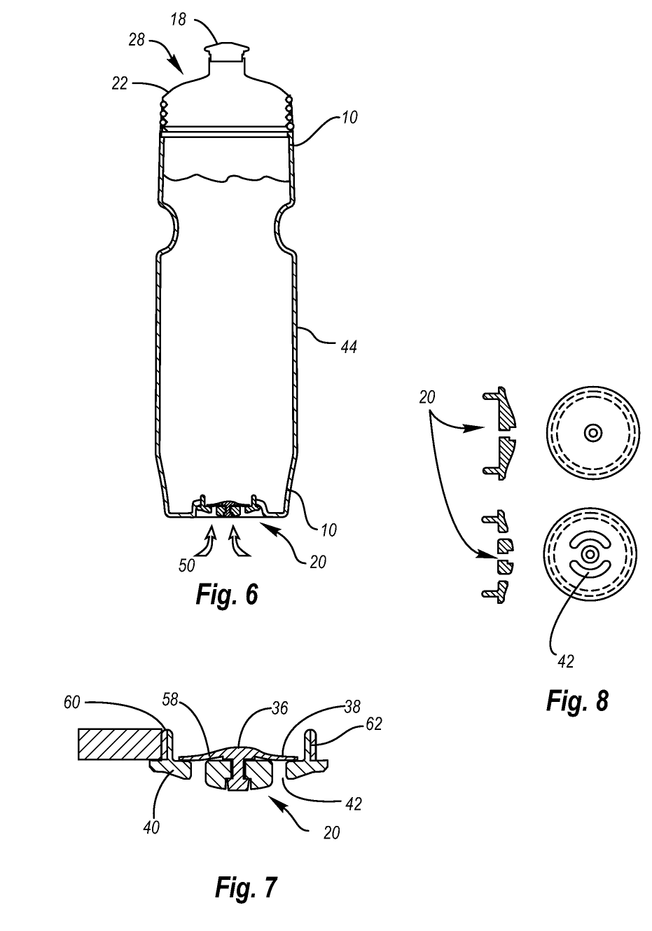

FIG. 3 shows the container of the invention with one preferred type of check valve. This type of check valve 20 is called an umbrella check valve 58, and includes a diaphragm 36 with flexible outer ring 38. The diaphragm 36 is positioned in a valve retainer 40, and in an upright position, the neutral pressure inside container body 12 and diaphragm 36 held in a preloaded position within valve retainer 40 causes outer ring 38 to seal the air passages 42. When inverted, and liquid 44 exits through sealable mouthpiece 18, reduced internal container pressure causes diaphragm 36 to lift from valve retainer 40 and permit air to pass through air passages 42 of the valve retainer 40, past the flexible outer ring 38. Valve retainer 40 is sealably mounted within mounting hole 60, an elastomeric overmold 62, holds and seals the retainer within mounting hole 60. Minivalve brand umbrella check valves are one type of check valve which are suitable for use with the container of the invention.

These two check valves are illustrative in nature and other check valves which can accomplish the same purpose could be utilized and fall within the scope of the invention.

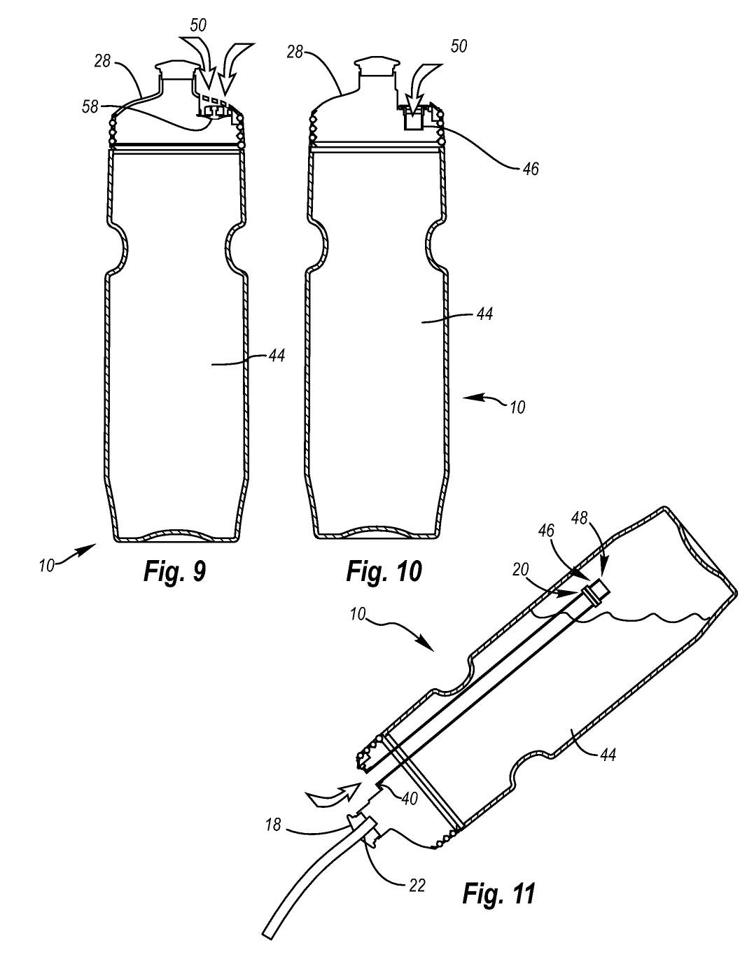

FIG. 4 is a view of another preferred embodiment of the invention, in which the check valve 20 is located on the lid assembly 28 of the liquid container 10. Shown in FIG. 4 is a container 10 with both the umbrella type check valve 58 and the duckbill type check valve 46. Also shown is the container 10 in an inverted position, in which air is allowed to enter the check valve 20 so that liquid 44 may exit freely through sealable mouthpiece 18 on the container cap 22. The duckbill check valve 46, comprising slit 48 is retained within lid assembly 28 by valve retainer 40, which also serves as a vented cover. The slit 48 seals liquid within container body 12 at neutral or positive pressure. When the pressure inside the sidewalls is lower than the pressure outside the sidewalls, then air is admitted through the slit 48.

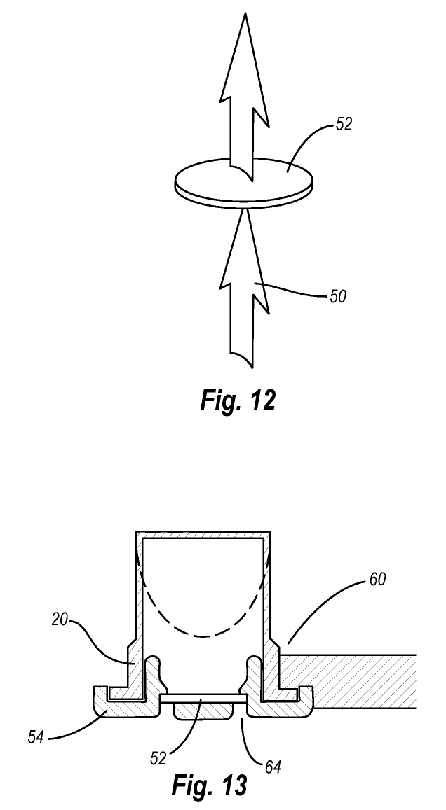

FIG. 5 is a view of the check valve 20 of the invention with an optional filter 52. The filter 52 would be especially useful in a dusty or smoky environment to keep contaminants from entering the container of the invention. In any environment, the presence of the filter 52 would give assurance to the user that the liquid in the container will remain clean as the liquid is consumed. As shown in FIG. 5, the filter 52 would be positioned at the inlet of check valve 20 and configured to filter air prior to air entering the check valve 20 and container body 12, the filter may be positioned, for example with barbs built into the base 54 of the valve retainer 40. Retainer 40 may be configured with vents 64 to allow air into check valve 20.

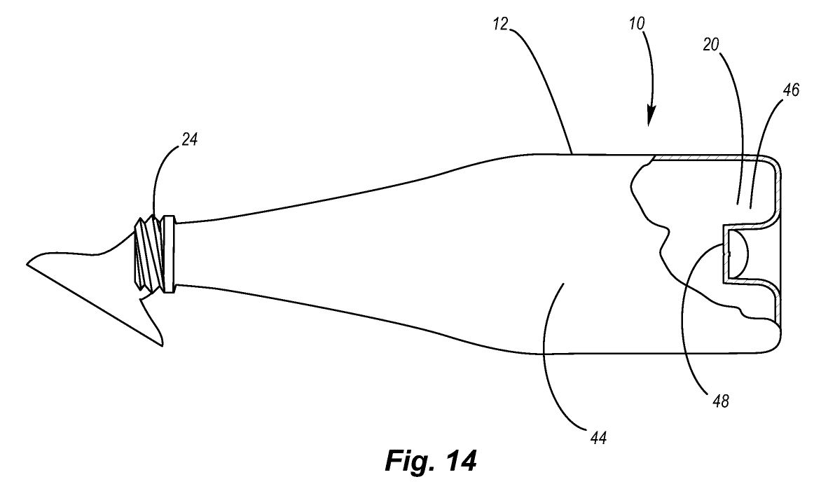

FIG. 6 is a preferred embodiment of the invention with check valve 20 located in the bottom of container body 12. The duckbill check valve 46 is sealably mounted within container body 12. Under neutral or positive pressure, slits 48 of duckbill check valve 46 remain sealed. As the rigid container is tilted, reduced internal pressure near the check valve 20 opens slits 48 causing contents to be poured freely. As the container is up-righted, neutral or positive pressure seals check valve 20. In an embodiment the contents 44 of container body 12 is a viscous substance.

The most important feature of the container of the invention is that it permits liquid to flow from the container in a smooth and rapid manner, and that it conveniently accomplishes pressure equalizing for beverages or viscous contents. With the container of the invention, the amount of fluid taken into the user's mouth is determined by the user tilting, squeezing or sucking from the container. Thus, the user determines how much, or how quickly to drink. Since there is little or no vacuum restriction within the container of the invention, the contents can be poured smoothly and liquid can exit the container by use of gravity, by suction from the user's mouth, or by the container being squeezed at the sides to force liquid from the container.

The container of the invention can be used with almost any type of bottle but is best utilized with bottles that have a certain degree of restriction as liquid exits the container. The check valve of the invention allows faster outflow of liquid from bottles such as these. It is reasonable to expect at least 30% more flow with the container of the invention, depending on the specific size of the opening, and on the capacity of the check valve.

The container of the invention is useful in physically demanding sports such as cycling, running, backpacking, team sports, professional sports, and any sport where hydration is important, time is limited, and the user may be out of breath or tired. The container of the invention may be used for rapid hydration in sports, to save time.

One advantageous feature of the container of the invention is that it allows smoother, steadier outpouring from the container. Thus, the outflow is much more laminar and less turbulent, which can be advantageous for certain fluids, such as carbonated beverages

Another important feature of the invention is reduced aeration of liquid in the container. Air that enters into the container, enters through the check valve, and in most configurations of the device would not bubble through the liquid in the container. By the mechanism of the check valve being in the bottom of the container, and the container being in an inverted position, air may pass into the container through the valve without passing through the liquid thereby not mixing air with the fluid.

Another feature of the container of the invention is reduced container deformation. The container of the invention eliminates the tendency of some containers to adhere to the user's tongue after liquid has been squeezed from a container. The reduced container deformation results in less noise which can be a factor in bottles made of thin walled and brittle plastic. Thus, the presence of a check valve is ideal for squeeze bottles which would otherwise experience extreme low pressure after being squeezed by the user to eject fluid.

Another advantage of the container of the invention is an improvement in sanitation. Due to reduced internal vacuum and suction, the tendency of liquid to flow from the user's mouth back into the container is reduced or eliminated. Thus, backwash and bacteria from the user's mouth are less likely to enter the container.

The container of the invention in the embodiment of a squeezable bottle provides for unique pump-action dispensing. When the container of the invention is squeezed outflow is permitted only through the opening. When the user stops squeezing the bottle, the flexible container regains its form quickly due to the equalization of pressure by the check valve. The container is then ready for additional squeezes. Thus, the container is capable of repeatable pump-action outflow.

The container of the invention can be utilized in pouring containers, squeeze containers and containers that are sucked. All of these may be fitted with caps, pop-its, twist off caps, twist to open caps, anti-spill or other bottle/container lid configurations, all of which may benefit from smoother, more rapid flow.

The container of the invention can be utilized in rigid pouring containers for pouring viscous contents such as ketchup, honey or caramel, and can significantly reduce the amount of time the user must wait for contents to outpour.

The container of the invention provides flow by demand, and allows the user to define how much flow is received, by the user controlling the amount of suction that is applied to the mouthpiece.

A number of different types of valves can be utilized, including duckbill valves, umbrellas valves, or other elastomeric valves available in materials such as food-safe silicone.

What is claimed is:

1. A container for liquids which comprises:
a container body, with a top side and a bottom side, and a sidewall connecting said top and bottom sides;
a mouthpiece in said container top configured for dispensing liquid, and a container cap associated with said mouthpiece, with said cap configured to close said mouthpiece or by removal of said cap to open said mouthpiece for dispensing liquid;
a check valve in said container which is configured to allow entry of air into said container body when pressure inside said container body is less than pressure outside said container body; wherein said container is configured for dispensing of said liquid from said container body when said container body is placed in an inverted position, with said check valve allowing air to enter said container to allow continuous outflow of liquid through said mouthpiece when said mouthpiece is in said open position.

2. A container for liquids which comprises:
a container body, with a top side and a bottom side, and a sidewall connecting said top and bottom sides;
a mouthpiece in said container top configured for dispensing liquid, with said mouthpiece configured to move between a closed and an open position,
a check valve in said container which is configured to allow entry of air into said container body when pressure inside said container body is less than pressure outside said container body; wherein said container is configured for dispensing of said liquid from said container body when said container body is placed in an inverted position, with said check valve allowing air to enter said container to allow continuous outflow of liquid through said mouthpiece when said mouthpiece is in said open position.

3. The container for liquids of claim 2 in which said container body is configured to allow liquid to drain from said container body by gravity when said container body is in an inverted position.

4. The container for liquids of claim 2 in which said container body is configured to allow liquid to drain from said container body when a user sucks on said mouthpiece when said container body is in an inverted position.

5. The container for liquids of claim 2 in which said container body further comprises flexible sidewalls and is configured to allow liquid to drain from said container body when a user compresses said flexible sidewalls when said container body is in an inverted position.

6. The container for liquids of claim 2 in which said check valve is positioned in said container bottom.

7. The container for liquids of claim 2 in which said check valve is positioned in a cap assembly on said container top.

8. The container for liquids of claim 2 in which said mouthpiece is a threaded neck on said container top configured to interface with a threaded cap for closing said container.

9. A container for liquids which comprises:
a container body, with a top side and a bottom side, and a sidewall connecting said top and bottom sides;
a mouthpiece in said container top configured to move between an open position and a closed position, for dispensing liquid;
a check valve in said container bottom side which is configured to allow entry of air into said container body when pressure inside said container body is less than pressure outside said container body; wherein said container is configured for dispensing of said liquid from said container body when said container body is placed in an inverted position, with said check valve allowing air to enter said container to allow continuous outflow of liquid through said mouthpiece when said mouthpiece is in said open position.

10. The container for liquids of claim 9 in which said container body is configured to allow liquid to drain from said container body by gravity when said container body is in an inverted position.

11. The container for liquids of claim 9 in which said container body is configured to allow liquid to drain from said container body when a user sucks on said mouthpiece when said container body is in an inverted position.

12. The container for liquids of claim 9 in which said container body further comprises flexible sidewalls and is configured to allow liquid to drain from said container body when a user compresses said flexible sidewalls when said container body is in an inverted position.

13. The container for liquids of claim 2 in which said check valve is positioned in a cap assembly on said container top.

14. The container for liquids of claim 13 in which said mouthpiece is built into said removable cap assembly, with said mouthpiece opening and closing said container body by moving said mouthpiece between an open and a closed position.

15. The container for liquids of claim 13 in which said cap further comprises a cap assembly which includes at least one attachment ridge for attachment of said cap assembly to said container body, with said cap assembly including said mouthpiece and a closure valve movable from a closed position to an open position, with the open position configured for allowing liquid to pass through the mouthpiece, and with the closed position configured for sealing said container.

16. The container of claim 13 in which said attachment ridge is a thread attachment for threading said cap assembly to said container body.

17. The container for liquids of claim 15 in which said attachment ridge is a ridge configured for inter-fitting engagement with a corresponding ridge or grove on said container body.

18. The container for liquids of claim 9 in which the container body further comprises a convex bottom side, so that said check valve does not protrude from a bottom plane of said container bottom.

19. A container for liquids which comprises:
a container body of resilient material for holding said liquid, with a top and a bottom, and a flexible sidewall, with said container body comprising a check valve in said container body, with said container configured to dispense liquid in a pump action manner, by repeatedly squeezing said container sidewalls to force liquid out, followed by releasing said sidewalls to allow air to enter said container body through said check valve;
a sealable mouthpiece in a top of said container body for closing and opening said container, with the mouthpiece movable from a closed position to an open position configured for allowing liquid to pass through the mouthpiece;
with said check valve in said container being configured to allow entry of air into said container body when pressure inside said container body is less than pressure outside said container body, and which is also configured to block outflow of air or water from within said container body; wherein
said container is configured to allow liquid to exit through said mouthpiece when said container is inverted by compressing of said container sidewall, with said check valve allowing air to enter said container to replace said liquid, to allow continuous outflow of liquid through said mouthpiece is in said open position.

20. The container for liquids of claim 2 in which said check valve is held in place with a check valve retainer configured to sealably mount said check valve in said container.

21. The container for liquids of claim 2 in which said check valve contains a filter for filtering air prior to air entering said check valve and said container body.

22. A container for viscous substances which comprises:
a container body, with a top side and a bottom side, and a sidewall connecting said top and bottom sides;
an opening in said container top configured for dispensing viscous substances, and a container cap associated with said opening, with said cap configured to close said opening or by removal of said cap to open said opening for dispensing viscous substances;
a check valve in said container which is configured to allow entry of air into said container body when pressure inside said container body is less than pressure outside said container body; wherein said container is configured for dispensing of said viscous substances from said container body when said container body is placed in an inverted position, with said check valve allowing air to enter said container to allow continuous outflow of viscous substances through said opening when said opening is in said open position.
